(19) United States
(12) Patent Application Publication
(10) Pub. No.: US 2023/0001538 A1
(43) Pub. Date: Jan. 5, 2023

(54) Electric power tool having a rotating tool

(71) Applicant: Hilti Aktiengesellschaft, Schaan (LI)

(72) Inventors: Georg HOLZMEIER, Marktoffingen (DE); Christan SATTLER, Biessenhofen (DE); Ralf GREITMANN, Kaufering (DE)

(21) Appl. No.: 17/781,458

(22) PCT Filed: Nov. 25, 2020
(86) PCT No.: PCT/EP2020/083308

§ 371 Date: Jun. 1, 2022

(30) Foreign Application Priority Data
Dec. 11, 2019 (EP) 19215269.2

(51) Int. Cl. B24B 47/12; B25F 5/00; B24B 55/10

(52) U.S. Cl. CPC B24B 47/12; B25F 5/008; B24B 55/102; B24B 27/08

(57) ABSTRACT

An electric power tool having a rotating tool. The electric tool is characterized in that a direction of rotation of the tool on the electric power tool can be set in dependence on an operating state of the electric power tool. The automatic settability of the direction of rotation of the electric tool is associated with the advantage that no gearbox for changing the direction of rotation, as in an internal combustion engine, is required. In addition, the user-friendliness of the electric power tool for the user can be significantly improved, since the user practically no longer has to worry about setting a “correct” direction of rotation of the tool. In a further aspect, the invention relates to a method for operating an electric power tool having a rotating tool, wherein the direction of rotation of the tool on the electric power tool is set in particular in dependence on whether or not a suction device is connected to the electric power tool.

The present invention relates to an electric power tool having a rotating tool. In a further aspect, the invention relates to a method for operating an electric power tool having a rotating tool.

### BACKGROUND

In the prior art, electric power tools are known with which surfaces can be machined or substrates can be severed. These electric power tools usually have a rotating tool, such as for example a cut-off disk, a cutting blade or a cut-off blade. The electric power tools known from the prior art are mostly characterized in that a fixedly defined direction of rotation of the tool is prescribed for them. This direction of rotation of the tool can preferably also be referred to as the rotary direction in the context of the invention.

### SUMMARY OF THE INVENTION

However, the fixedly prescribed direction of rotation of the tool of the electric power tool severely limits the user-friendliness of the electric power tool to the extent that the electric power tool can only be used well for certain applications, namely for those tasks that can be performed particularly well with the prescribed direction of rotation of the tool. For all other tasks, working with a conventional electric power tool with a fixedly prescribed direction of rotation of the tool can under certain circumstances be very strenuous or, for example, involve a high level of dust exposure for the user.

However, some power tools are already known in the prior art in which the user can set a direction of rotation of the tool. For example, US 2015 0282 337 A discloses a machine tool in which the power supply to the electric motor of the machine tool can be set by an electronic switch device. US 2019 0319 563 A describes another machine tool in which a direction of rotation of the tool can be set, it being possible for a distinction to be made between a forward and a reverse direction. The disadvantage with the machine tools described in the prior art is that the direction of rotation of the tool usually has to be set manually by a user. This can lead to the fact that the user's attention is drawn to the switching process, so that the user has less attention available for the actual work process. This can result in mistakes in work or risks to the user.

It is an object of the present invention to provide an electric power tool having a motor and a rotating tool with improved user-friendliness and a particularly wide range of applications. The electric power tool to be provided should, in particular, be able to be used particularly flexibly in different application situations. It should be possible in this context to work with the electric power tool in different application scenarios without drawing the user's attention too much to a selection between different directions of rotation of the tool of the electric power tool. The application situations should preferably enable particularly good suction extraction of the occurring dust or should be perceived as particularly less tiring by the user.

The present disclosure provides an electric power tool having a rotating tool. The electric tool is characterized in that a direction of rotation of the tool on the electric power tool can be set in dependence on an operating state of the electric power tool. Since, in the proposed electric power tool, the direction of rotation of the tool can be set in dependence on an operating state of the electric power tool, a technical possibility is provided with which in particular the aspect of user-friendliness of the electric power tool can be improved in conjunction with a wide range of applications. In particular, the preferably automatic setting of the direction of rotation of the tool of the electric power tool ensures that the setting does not have to be performed manually by the user, which often ties up a high proportion of the user's attention. In addition, the operation of the electric power tool can be optimally adapted or coordinated with the connection or the presence of a suction device by means of the invention. This in turn also leads to improved suction extraction of dust from a work area of the electric power tool. A suction device within the meaning of the invention can be a vacuum cleaner or a dust extractor. It can be a dry vacuum cleaner or a wet-dry vacuum cleaner. So-called water management systems (WMS) can also be suction devices within the meaning of the invention. The term “suction device” is to be understood within the meaning of the invention in such a way that it means devices which are at least also set up to suck up dust and dirt dissolved in air or in water.

In particular, the invention provides a possibility of providing an optimal direction of rotation of the tool of the electric power tool in each case for different applications of the electric power tool. In the context of the present invention, this is made possible in particular by the fact that the electric power tool is advantageously set up to recognize whether a suction device is connected to a dust or protective hood. For this purpose, the electric power tool can for example comprise suitable detection means. The direction of rotation of the tool of the electric power tool can then be set in dependence on whether or not a suction device or a suction hose connection is recognized. In the context of the invention, it is particularly preferred that the direction of rotation of the tool is set automatically, that is to say without any further action on the part of the user. This takes the burden off the user and allows the latter to direct his full attention to performing the work to be done with the electric power tool. It is preferred in the context of the invention that the detection means are arranged in a region of the respective connection pipe for the suction hose.

It is preferred in the context of the invention that the operating state of the electric power tool indicates whether or not a suction device is connected to the electric power tool. In a very particularly preferred embodiment, the invention thus relates to an electric power tool in which the direction of rotation of the tool can be set in dependence on whether or not a suction device is connected to the electric power tool.

For this purpose, it is preferred in the context of the invention that the electric power tool comprises means for recognizing a suction device. These are preferably means for sensory detection of a suction device. These means are set up in particular to recognize the connection of a suction hose of a suction device. In the context of the invention, the term “suction hose” preferably describes such a hose with which, for example, a nozzle or a suck-in device can be connected to a suction device. A person skilled in the art is familiar with such suction hoses as are known, for example, from standard commercial domestic vacuum cleaners. In the context of the present invention, a suction hose can be used to connect a suction device to the electric power tool in order to extract by suction dust that occurs when working with the electric power tool. The suction hose opens in the region of the electric power tool, in particular in the region of a so-called dust hood, which from the outset prevents the dust occurring from being widely distributed over a large area of space or volume. Rather, the dust that occurs when the electric power tool is in operation is collected in the dust hood or another accessory device, from where it can be extracted by suction particularly well and efficiently.

The connection to the dust hood or to the electric power tool can preferably be made with an adapter device, which in the context of the invention can preferably also be referred to as a suction-extraction device. This suction-extraction device can, depending on the working direction of the electric power tool or depending on the direction of rotation of the tool of the electric power tool, be arranged in the direction of the electric power tool or on the side of the dust or protective hood facing away from the electric power tool. In other words, the electric power tool can have a suction-extraction device whose position can be selected in dependence on a working direction of the electric power tool or in dependence on a direction of rotation of the tool of the electric power tool. In the context of the invention, it is very particularly preferred that the suction-extraction device is arranged on the side of the dust hood into which the electric power tool is moved. In the context of the invention, this preferably means that the suction-extraction device is preferably arranged between the dust hood and electric power tool when the electric power tool is operated in the pulling working direction and the tool of the electric power tool is arranged in the “counterclockwise” direction of rotation on the front side of the protective hood facing away from the electric power tool when the electric power tool is operated in the pushing working direction and the tool of the electric power tool rotates in the “clockwise” direction of rotation.

It is preferred in the context of the invention that a suction hose connection is arranged on the electric power tool in dependence on a direction of rotation of the tool of the electric power tool. In other words, the arrangement or the position of the suction hose connection is dependent on the direction of rotation in which the tool of the electric power tool rotates. In the context of the invention, it is preferred that the suction hose connection is situated on a power tool-side end of a protective hood of the tool of the electric tool when the tool rotates counterclockwise and/or the electric power tool is operated in a pulling working direction, while the suction hose connection is preferably situated on a power tool-averted, front end of a protective hood of the tool of the electric tool when the tool rotates clockwise and/or the electric power tool is operated in a pushing working direction. With the invention, a possibility can thus be provided for the optimal arrangement of a suction hose connection or a suction-extraction device in the region of a protective or dust hood of an electric power tool. The parameters according to which the position of the suction hose connection or of the suction-extraction device is determined in the context of the present invention are, for example, the working direction of the electric tool or the direction of rotation of the tool of the electric power tool. These parameters can be decisive for the operating state of the electric power tool.

It is preferred in the context of the invention that the means for recognizing a suction device are formed by a mechanical switch, wherein the mechanical switch can preferably be configured as a microswitch. The use of a microswitch is particularly preferred when the connection of a suction hose is to be detected with the detection means. The means for recognizing the suction device are preferably set up to recognize the connection of a suction-extraction hose to a fixedly attached suction-extraction opening on a dust hood. They can also be set up to recognize suction-extraction accessories that are mounted as required on the dust hood for the purpose of suction extraction. It is preferred in the context of the invention that the recognition means comprise Hall sensors or magnets for recognizing the presence of the devices mentioned. Alternatively or in addition, the detection means can comprise capacitive and/or inductive sensors for recognizing the suction device, the suction hose connection or the suction-extraction accessories.

In electric power tools having a separate dust suction extractor, which is designed, for example, as an accessory device, the direction of rotation can preferably be automatically adapted when a magnet is arranged as a detection means on the accessory device or a Hall sensor is arranged as a detection means on a blade guard of the electric power tool.

In a second aspect, the invention relates to a method for operating an electric power tool having a rotating tool, the method comprising the following method steps:
a) provision of an electric power tool having a rotating tool,
b) detection of an operating state of the electric power tool with detection means,
c) operation of the electric power tool in dependence on the detected operating state of the electric power tool.

In the context of the proposed method, it is particularly preferred that the direction of rotation of the tool of the electric power tool is set in dependence on whether a suction device is connected to the electric power tool or whether a connection of a suction device is recognized by corresponding detection means. This recognition takes place with detection means. In the context of the invention, it is very particularly preferred that the detection means are set up in particular to detect, as the operating state of the electric power tool, whether a suction device is connected to the electric power tool. In this respect, the method can also be referred to as a method for setting a direction of rotation of the tool of an electric power tool in dependence on a recognition of a suction device. In other words, in the context of the present invention, a direction of rotation of the tool of the electric power tool is set in dependence on whether or not a suction device is connected to the electric power tool. The method can then comprise the method steps of “checking whether a suction device is connected to the electric power tool” and of “setting a direction of rotation of the tool of the electric power tool in dependence on the recognition of a suction device on the electric power tool”. The method can furthermore comprise the method step of arranging a suction hose connection or a suction-extraction device in dependence on a direction of rotation of the tool of the electric power tool or in dependence on a working direction of the electric power tool. Here, the position of the suction hose connection or of the suction-extraction device is adapted to the direction of rotation of the tool or the working direction of the electric power tool in such a way that the dust suction extraction is optimally set to the operation of the electric power tool, so that efficient dust suction extraction can be provided in a requirement-optimized manner.

In the context of the invention, it is very particularly preferred that the tool of the electric power tool rotates clockwise when a suction device is connected to the electric power tool, and the tool of the electric power tool rotates counterclockwise when no suction device is connected to the electric power tool.

It is also preferred in the context of the invention that the direction of rotation of the tool of the electric power tool is indicated by indicating means for the direction of rotation. In the context of the invention, this preferably means that the electric power tool comprises such indicating means with which the direction of rotation of the tool of the electric power tool can be indicated, preferably in a clearly visible manner to the user of the electric power tool. For example, a light-emitting diode or an LED can be used as the indicating means to indicate the current direction of rotation of the tool for the user, so that the user can adjust to the respective direction of rotation while working. A small screen or some other indicator is also conceivable. The indication of the direction of rotation of the tool of the electric power tool is particularly important and represents a significant advantage of the invention for the user because the user forces can change considerably depending on the direction of rotation. For the user, for example, it is particularly important to know how the electric power tool will react during possible jamming of the tool. This means that the user of the electric power tool can prepare for a kickback much better than with those electric power tools in which the tool direction of rotation is not indicated.

In the context of the invention, it is preferred that the electric power tool comprises a motor, the motor being a brushless motor. It represents a surprising innovation in the field of brushless motors that electric tools can be provided in which the direction of rotation of the rotating tool can be set. The settability of the direction of rotation of the electric tool when using a brushless motor is associated with the advantage that neither a gearbox for changing the direction of rotation, as in an internal combustion engine, nor a mechanism for switching the commutation, as in a brush motor, is required. In this way, a particularly user-friendly and flexibly usable electric tool can be provided.

The term “settability of the direction of rotation of the electric tool” preferably means in the context of the invention that a direction of rotation of the tool of the electric power tool can be set in dependence on the requirements of the task to be performed. For example, a “clockwise” direction of rotation can be set. For other applications, it can be preferred that the “counterclockwise” direction of rotation is set. The settability of the direction of rotation of the electric power tool preferably means in the context of the invention that it is possible to switch back and forth between the two opposite “clockwise” and “counterclockwise” directions of rotation, depending on the preference of the user of the electric power tool. An example of a “clockwise” direction of rotation is illustrated in FIG. 1. An example of a “counterclockwise” direction of rotation is illustrated in FIG. 2, the direction of rotation being indicated by the circular arrow in each case.

Switching can be effected, for example, by setting a switch. This setting can be done mechanically, for example. In the context of the invention, it can also be preferred that the setting is transmitted to the electric power tool via changed settings by means of a communication connection. The changing of settings can be understood in the sense of the invention as actuation of a switch. The switch can be queried by a control unit or the power electronics of the electric power tool. In the context of the invention, it can also be preferred that, depending on the switch position, the control software for controlling the motor is selected accordingly.

It is preferred in the context of the invention that the electric power tool comprises electronics for setting the direction of rotation of the tool of the electric power tool. It is very particularly preferred in the context of the invention that the tool of the electric power tool rotates clockwise when a suction device is connected to the electric power tool, while the tool of the electric power tool rotates counterclockwise when no suction device is connected to the electric power tool. The detection means with which the presence of the suction device can be detected can for example be part of the electronics of the electric power tool. The detection means can alternatively be connected to or be communicating with the electronics, wherein the connection and/or the communication can be of wired or wireless configuration. In the context of the invention, it can also be preferred that the function of detecting the suction device or its connection is carried out or taken over by the electronics of the electric power tool.

Tests have shown that the “clockwise” direction of rotation is particularly preferred when the electric power tool is used in conjunction with dust suction extraction. When the direction of rotation of the tool of the electric power tool is “clockwise”, the tool, in a front region of the power tool, preferably rotates away from the substrate to be machined or away from the user of the electric power tool. As a result, the comminuted cuttings can receive a movement impulse away from the user, so that the user is exposed to reduced dust exposure from the outset owing to the direction of rotation of the tool of the electric power tool when the electric power tool is operated in the “clockwise” direction of rotation. It can also be preferred in the context of the invention that the cuttings are conveyed away from the preferably smooth substrate. This advantageously creates the prerequisite for improved and more complete suction extraction. In the context of the invention, it is very particularly preferred that the electric power tool interacts with a dust hood which is set up to suck up the cuttings produced when cutting off or machining the substrate and, for example, to remove them from a breathing zone of the user of the electric power tool.

In the case of the “counterclockwise” direction of rotation, it is preferred in the context of the invention that the tool rotates on the substrate to be machined in the direction of the user of the electric power tool. It is preferred in the context of the invention that the direction of rotation of the tool supports the direction of movement of the user. Tests have shown that this settable direction of rotation of the tool or of the electric power tool is particularly advantageous for applications that are perceived as very burdensome by the user. The burden can be caused, for example, by working with great force or by time-consuming, long-lasting work having to be carried out. In this respect, operating the electric power tool in the “counterclockwise” direction of rotation enables particularly comfortable work with the electric power tool that is not very physically burdensome for the user. Since settability of the direction of rotation of the tool of the electric tool is made possible with the present invention, the user of the electric power tool can set the optimum direction of rotation of the tool on the electric power tool depending on the application and thus advantageously work with particularly little dust or with reduced physical burden.

In the context of the invention, it is preferred that cooling of the electric power tool is designed to be substantially independent of the direction of rotation. In other words, it is preferred in the context of the invention that the cooling of the electric power tool works independently of the direction of rotation of the tool of the electric power tool and that a mode of operation of the cooling is not influenced by switching the direction of rotation of the tool. The cooling of the electric power tool is preferably set up in particular to protect components of the electric power tool, such as the motor and/or power electronics, from overheating. In the context of cooling the electric power tool, a fluid is preferably led past the components of the electric power tool to be cooled. The fluid can preferably be a water-based fluid or a gas mixture, such as air. The fluid is preferably led past the components of the electric power tool to be cooled in suitable pipes or ducts, with the temperature difference between the components to be cooled and the cooling fluid resulting in a heat exchange between the motor and/or line electronics in the direction of the cooling fluid. It was completely surprising that, in the context of the present invention, it is also possible to provide cooling of the electric power tool that is independent of the direction of rotation.

The provision of cooling, which is substantially independent of the direction of rotation, for the motor of the electric power tool can be made possible, for example, by using a fan in the region of cooling of the electric power tool, which fan preferably has no preferential direction. In the context of the invention, this preferably means that the elements on the fan wheel, which serve to guide the cooling fluid, can be formed by straight ribs. Unlike curved cooling ribs, straight cooling ribs do not deliver the cooling fluid in a preferential direction, but rather in a substantially radial direction. As a result, the cooling proposed in the context of the proposed electric power tool when using a fan wheel without a preferential direction can be designed to be substantially independent of the direction of rotation, since in this way comprehensive cooling of the motor of the electric power tool can be ensured in both operating directions of the tool. In the context of the invention, it can be preferred that this cooling power is substantially 100% for both directions of rotation of the tool. However, it can also be preferred that a cooling power can be set for the cooling that is less than 100%. In other words, it is preferred in the context of the invention that different cooling powers can be set for the cooling of the electric power tool, in particular in dependence on the direction of rotation of the tool of the electric power tool. This can be advantageous in cases when a first operating mode of the electric power tool requires a lower cooling power than a second operating mode of the electric tool. A cooling power of less than 100% can be provided, for example, by using a fan in the region of cooling of the electric power tool that has an only slightly pronounced preferential direction. As a result, the cooling in the preferential direction, when the tool of the electric power tool is operated in a first direction of rotation, for example, can achieve a 100% cooling power and in the non-preferential direction a lower cooling power, but one which is sufficient to achieve cooling of the electric power tool when the tool of the electric power tool is operated, for example, in a second direction of rotation. In the context of the invention, cooling adapted in this way to the requirements should also fall under the term “cooling of the electric power tool that is substantially independent of the direction of rotation”.

It is preferred in the context of the invention that the electric power tool comprises a direction of rotation indicator. In other words, the electric power tool preferably comprises an indicating means for the direction of rotation of the tool of the electric power tool. The indicating means can be, for example, a small display, a screen or a monitor. The indicating means can preferably be designed as a touchscreen, so that inputs can advantageously be performed by contact through the user's finger or with a special pen. The indicating means can, for example, also comprise small lamps or LEDs which, for example, are colored differently. For example, an LED in color A can indicate the “counterclockwise” direction of rotation, while an LED in color B indicates the “clockwise” direction of rotation.

In the context of the invention, it is very particularly preferred that the electric power tool is a cut-off grinder, a diamond cut-off grinder or an angle grinder. In this respect, the invention relates in particular to cut-off grinders, diamond cut-off grinders or angle grinders in which, as a departure from the prior art, the direction of rotation of the tool can be switched depending on the requirements of the work to be performed, with the motor of the electric power tool being a brushless motor. In the context of the present invention, a choice can preferably be made between the “clockwise” and “counterclockwise” directions of rotation. For this purpose, the electric power tool can for example comprise a switch device. This can be, for example, a toggle switch or a slide switch which preferably allows two switching positions. Preferably, respectively one switching position corresponds to one direction of rotation of the electric power tool.

In one exemplary embodiment, the invention relates to a cut-off or angle grinder, the drive preferably being implemented with a brushless motor. The tool of the cut-off or angle grinder is preferably equipped with an automatically settable direction of rotation, so that a direction of rotation of the cut-off disk or of the cut-off blade on the electric power tool is set without any action on the part of the user. This advantageously makes it possible to provide a cut-off or angle grinder that is particularly easy to configure and that is particularly user-friendly on account of its settable tool direction of rotation. It has been shown that with an electric power tool whose tool rotates clockwise, particularly good suction extraction of the cuttings can be achieved in conjunction with a corresponding dust hood for the suction extraction. For this purpose, the electric power tool or the dust hood can be connected to a vacuum cleaner or a dust extractor, for example. Furthermore, it has been shown that an electric power tool whose tool rotates counterclockwise leads to a surprisingly low level of user fatigue. In other words, the physical burden for the user of the electric power tool can be considerably reduced with the invention when the tool of the cut-off or angle grinder is operated in a counterclockwise direction. A further advantage of the invention is that the direction of rotation of the tool of the electric power tool can in particular be selected in dependence on the accessibility of the substrate or of the material to be cut off.

In the context of the invention, it is preferred that, in the case of a brushless motor, the direction of rotation of the tool can be changed by means of software control. Here, the direction of rotation of the tool of the electric power tool is preferably set automatically, that is to say in particular without any action on the part of the user of the electric power tool. In the context of the invention, it is preferred here that sufficiently large cooling of the power tool components is made possible for both directions of rotation of the motor. A brushless motor can preferably be operated with mains operation or else with one or more batteries and/or accumulators.

In a preferred embodiment of the invention, a suitable sensor-based detection of the connection of a suction hose is provided for the preferably automatic setting of the tool direction of rotation by the electric power tool. If the suction hose connection can be closed with a flap or a cover, for example, it can be detected, for example by a microswitch, whether the flap or is closed. An open flap is interpreted in the context of the invention in such a way that a suction hose is connected, that is to say a suction device is present. A closed flap is interpreted in the context of the invention in such a way that no suction hose is connected, that is to say no suction device is present. It is preferred in the context of the invention that the electric power tool is set up to set the direction of rotation of the tool accordingly in dependence on this information. In particular, electronics or a control device of the electric power tool can be used for this purpose. In particular, when the suction hose is not connected, the “counterclockwise” direction of rotation is set, while when the suction hose is connected, the “clockwise” direction of rotation is set.

Key advantages of the invention are that the direction of rotation of the tool of the electric power tool can be optimally adapted to an application of the electric power tool. Furthermore, with the invention, the implementation of the dust suction extraction of the electric power tool can be adapted to the clockwise or counterclockwise direction of rotation. This enables a significantly improved degree of suction extraction to be achieved. Moreover, an additional depth stop can be provided with which substantially dust-free indoor working can be realized.

For cutting-to-length applications of the electric power tool, it is possible, for example, for the pulling working direction preferably used by the user to be implemented if dust suction extraction is not necessary here. With suction extraction in the front region of the protective or dust hood, the suction hose connection can be very easily integrated into the protective or dust hood. This has the advantage that the user does not have to mount and demount an additional suction-extraction device. The suction-extraction device can therefore also not be lost on the construction site. In the case of changing applications with or without suction extraction, only the closure or the opening of the suction hose connection on the hood is required. The suction-extraction device can advantageously be operated with virtually all common suction devices suitable for construction sites, such as vacuum cleaners or dust extractors.

In the case of electric power tools, for example a cut-off grinder, in which the dust suction extractor is designed as a separate accessory device, the direction of rotation can preferably be automatically adapted when the accessory is mounted, for example with a magnet on the accessory or with a Hall sensor on a blade guard of the tool of the electric power tool. It is also conceivable, in addition to the direction of rotation, also to change other operating parameters, such as rotational speed, torque and the like, in order to optimize the dust suction extraction.

The proposed electric power tool is also formed by the following features for recognizing a suction device and for automatically changing or setting a direction of rotation of the tool of an electric power tool:

To enable both directions of rotation in a cut-off grinder, the following points must be taken into consideration in the power tool configuration:
The motor fan is preferably symmetrically suitable for both directions of rotation.
The tool is preferably suitable for use in both directions of rotation. If the electric power tool is a cut-off grinder, this applies in particular to the cut-off or cutting disks, which in particular can also be studded with diamonds in order to improve the cutting performance.
The gear mechanism of the electric power tool preferably has straight gear teeth, which are also suitable for both directions of rotation.
The electric power tool preferably has an electronically commutated motor that is suitable for both directions of rotation.
The tool fastening is preferably suitable for both directions of rotation of the tool. In the context of the invention, this means in particular that the tool fastening is not loosened in both directions of rotation. In other words: The tool does not become detached from the electric power tool in an undesired manner, regardless of the direction of rotation in which the electric power tool is operated.

### BRIEF DESCRIPTION OF THE DRAWINGS

Further advantages of the invention will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical and similar components are denoted by the same reference signs. In the figures:

FIG. 1 shows a view of a preferred embodiment of the electric power tool,

FIG. 2 shows a view of a further preferred embodiment of the electric power tool,

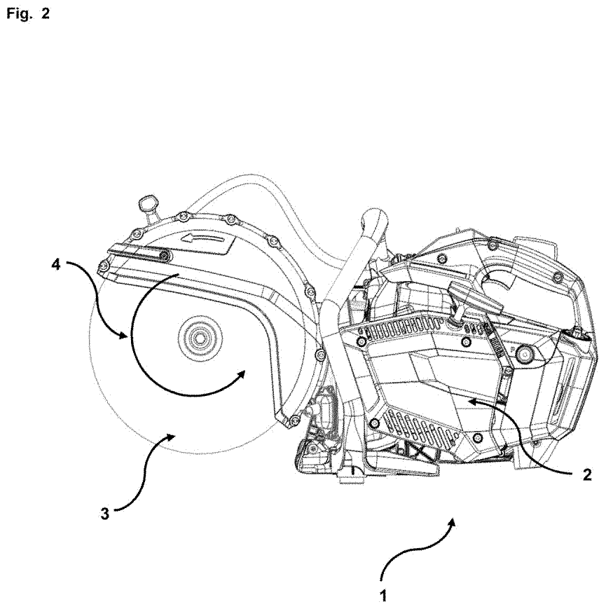

FIG. 3 shows a view of a preferred embodiment of a fan wheel for cooling that is independent of the direction of rotation,

FIG. 4 shows a view of a preferred embodiment of the electric power tool in which the tool rotates counterclockwise,

FIG. 5 shows a view of a preferred embodiment of the electric power tool in which the tool rotates counterclockwise, in the pulling working direction,

FIG. 6 shows a view of a preferred embodiment of the electric power tool in which the tool rotates clockwise,

FIG. 7 shows a view of a preferred embodiment of the electric power tool in which the tool rotates clockwise, in the pushing working direction.

### DETAILED DESCRIPTION

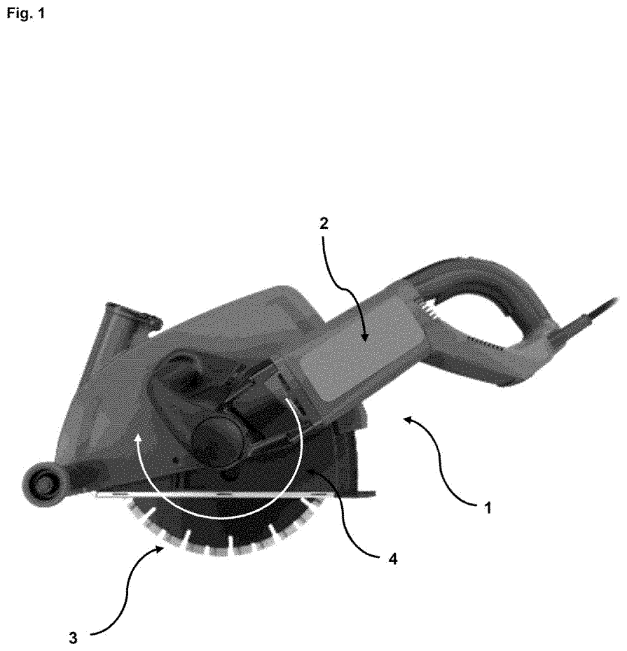

FIG. 1 shows a proposed electric power tool (1) having a motor (2) and a rotating tool (3). In the context of the invention, it is very particularly preferred that the electric power tool (1) is a cut-off grinder, a diamond cut-off grinder or an angle grinder. A direction of rotation (4) of the tool (3) can be set on the electric power tool (1). The motor (3) is a brushless motor. The electric power tool (1), which is depicted in FIG. 1, is a cut-off grinder whose cut-off disk (3) rotates in the clockwise direction. As a result, dust or cuttings arising during the cutting-off or cutting process can be removed from the working region of the tool (3) in such a way as to be moved away or transported away from the user of the electric power tool (1). The electric power tool (1) can comprise a dust hood which preferably surrounds the rotating tool (3) and which is preferably set up to extract by suction the dust or the cuttings, for example in conjunction with a dust suction-extraction device. This advantageously prevents the dust from being inhaled by the user and entering his airways, where it can lead to health impairments.

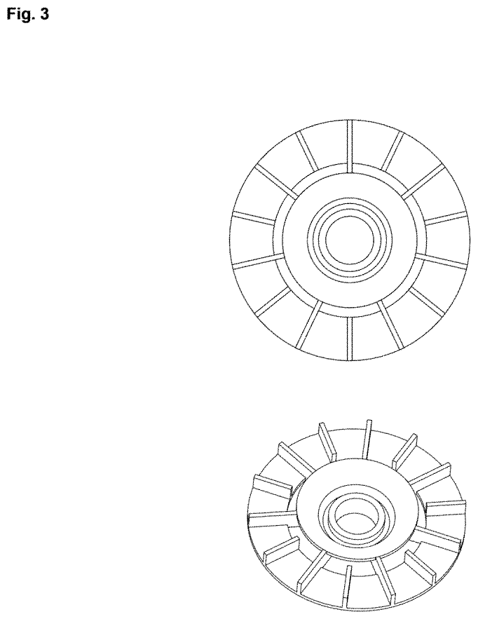

In a preferred embodiment of the invention, the electric power tool (1) can comprise a cooling system (see. e.g. FIG. 3). The cooling of the electric power tool (1) is preferably designed to be independent of the direction of rotation. In other words, the cooling of the electric power tool (1) can be designed such that it can be operated independently of the direction of rotation (4) of the tool (3) of the electric power tool (1). The cooling of the electric power tool (1) is preferably set up to protect those components of the electric power tool (1) from undesired overheating that are particularly relevant for the operation of the electric power tool (1), such as for example the motor (2) or the power electronics.

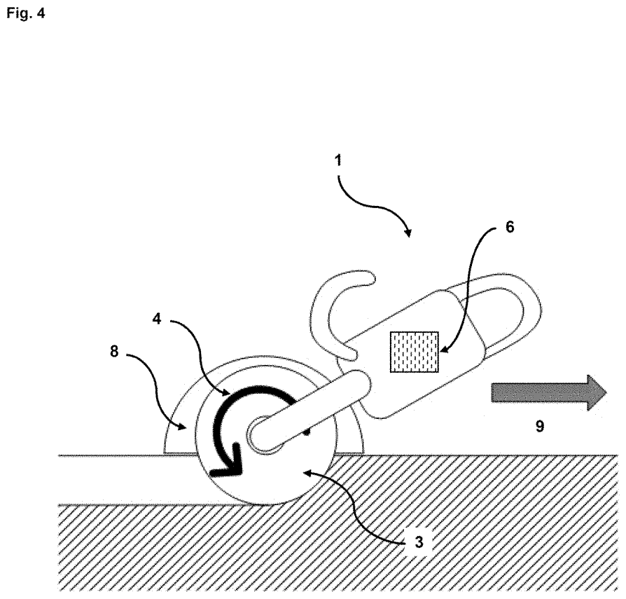

In a preferred embodiment of the invention, the electric power tool (1) can comprise an indicating means (6) for the direction of rotation (4) (see, e.g., FIG. 4). In other words, it is preferred in the context of the invention that the electric power tool (1) comprises a direction of rotation indicator (6). This direction of rotation or rotary direction indicator (6) can be used to indicate on the electric power tool which direction of rotation (4) of the tool (3) is currently set. The indicating means (6) is preferably situated at a point on the electric power tool (1) that is readily visible to its user.

FIG. 3 shows a preferred embodiment of a fan wheel for cooling that is substantially independent of the direction of rotation. Cooling ribs can be seen here which preferably lead radially outward from a center point of the fan wheel disk. The fan wheel illustrated in FIG. 3, with preferably radially extending, straight-design cooling ribs, advantageously has no preferential direction when transporting a cooling fluid. As a result, a fan wheel, as illustrated by way of example in FIG. 3, allows cooling to be provided within the electric power tool (1), which can be used for both directions of rotation (4) of the tool (3) of the electric power tool (1).

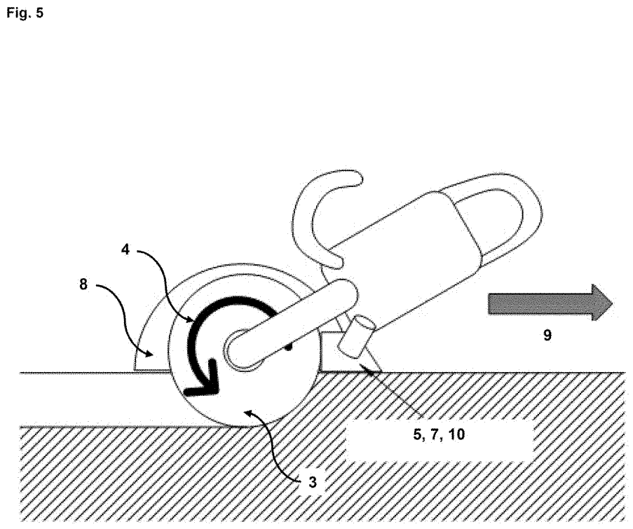

FIG. 4 shows an electric power tool (1) whose tool (3) rotates counterclockwise. The preferred working direction of such an electric power tool (1) in which the tool (3) rotates counterclockwise is the “pulling” working direction (9). In the context of the invention, this preferably means that the electric power tool (1)—in FIG. 4 by way of example a cut-off grinder—is pulled in the direction of the user during use. This is intended to prevent what is known as a kickback, that is to say a rapid rebound of the power tool (1) upon sudden jamming in the substrate, which is observed in particular in pushing applications. In the case of electric power tools (1) which, on account of the direction of rotation (4) of their tool (3), are used in particular in the pulling working direction (9), it is particularly preferred that a suction hose connection (7) of a dust hood (8) is arranged in particular at a power tool-side end of the protective hood (8). Such an arrangement of a suction hose connection (7) for a dust hood (8) is illustrated in FIG. 5. In the exemplary embodiment illustrated in FIG. 5 of the electric power tool (1), a suction hose connection (7) for a dust hood (8) is present in particular at the power tool-side end of the protective hood (8). The suction hose connection (7) is preferably present in conjunction with a suction-extraction device (10). This can preferably be an adapter between the dust hood (8) and the suction hose in order to fasten the suction hose of the suction device to the dust or protective hood (8) of the electric power tool (1). It is preferred in the context of the invention that the detection means (5) are arranged in a region of the respective connection pipe for the suction hose. The detection means (5) can, however, be arranged at many different positions on the electric power tool (1).

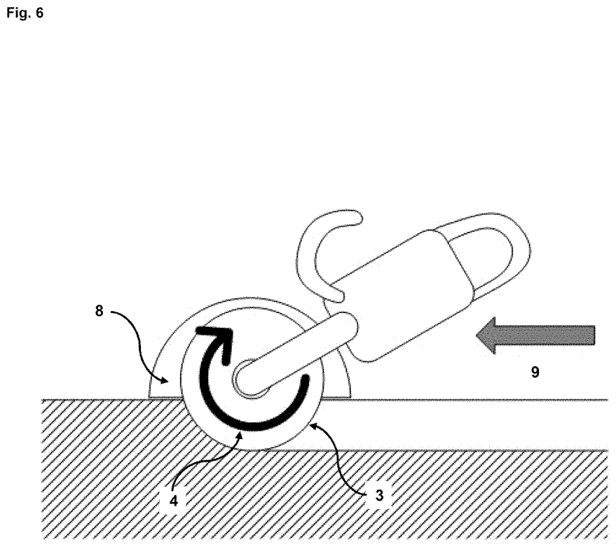

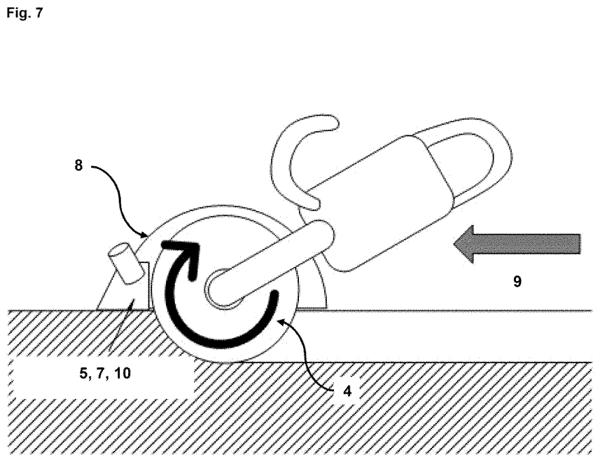

FIGS. 6 and 7 show, analogously to FIGS. 4 and 5, electric power tools (1) whose tools (3) rotate in the clockwise direction and which are operated accordingly in the “pushing” working direction (9). In the electric power tool (1) illustrated in FIG. 7, a suction hose connection (7) for a dust hood (8) or a suction-extraction device (10) is therefore situated on a power tool-averted side of the protective hood (8). The suction hose connection (7) thus leads the electric power tool (1) when the electric power tool (1) is operated in the “pushing” working direction (9).

### LIST OF REFERENCE SIGNS

1 Electric power tool, for example a cut-off grinder
2 Motor
3 Tool
4 Direction of rotation
5 Detection means
6 Indicating means for the direction of rotation of the tool
7 Suction hose connection
8 Dust or protective hood
9 Working direction of the electric power tool
10 Suction-extraction device

What is claimed is:

1-15. (canceled)

16. An electric power tool comprising:
a rotating tool, a direction of rotation of the rotating tool on the electric power tool settable in dependence on an operating state of the electric power tool.

17. The electric power tool as recited in claim 16 further comprising a brushless motor.

18. The electric power tool as recited in claim 16 wherein cooling of the electric power tool is designed to be independent of the direction of rotation.

19. The electric power tool as recited in claim 16 further comprising an indicator for the direction of rotation.

20. The electric power tool as recited in claim 16 wherein the electric power tool is a cut-off grinder, a diamond cut-off grinder or an angle grinder.

21. The electric power tool as recited in claim 16 wherein the operating state indicates whether a suction device is connected to the electric power tool.

22. The electric power tool as recited in claim 16 wherein the electric power tool comprises means for recognizing a suction device.

23. The electric power tool as recited in claim 22 wherein the means for recognizing a suction device includes a microswitch, a magnet or a Hall sensor.

24. The electric power tool as recited in claim 16 further comprising electronics for setting the direction of rotation of the rotating tool of the electric power tool.

25. The electric power tool as recited in claim 16 wherein the rotating tool of the electric power tool rotates clockwise when a suction device is connected to the electric power tool, and the rotating tool of the electric power tool rotates counterclockwise when no suction device is connected to the electric power tool.

26. The electric power tool as recited in claim 16 further comprising a suction hose connection or a suction-extraction device arranged on the electric power tool in dependence on a direction of rotation of the tool of the electric power tool or in dependence on a working direction of the electric power tool.

27. A method for operating an electric power tool having a rotating tool, the method comprising the following method steps:
a) providing the electric power tool as recited in claim 16;
b) detecting the operating state of the electric power tool with a detector; and
c) operating the electric power tool in dependence on the detected operating state of the electric power tool.

28. The method as recited in claim 27 wherein the detector is set up to detect, as the operating state of the electric power tool, whether a suction device is connected to the electric power tool.

29. The method as recited in claim 27 wherein the direction of rotation of the rotating tool of the electric power tool is set in dependence on whether or not a suction device is connected to the electric power tool.

30. The method as recited in claim 27 wherein the direction of rotation of the rotating tool of the electric power tool is indicated by an indicator for the direction of rotation.
